(19) United States
(12) Patent Application Publication
(10) Pub. No.: US 2026/0163683 A1
(43) Pub. Date: Jun. 11, 2026

(54) TIME DOMAIN PDCCH DMRS PATTERN WITH A LONG CORESET

(71) Applicant: QUALCOMM Incorporated, San Diego, CA (US)

(72) Inventors: Morteza SOLTANI, San Diego, CA (US); Weimin DUAN, San Diego, CA (US); Gabi SARKIS, San Diego, CA (US); Jing SUN, San Diego, CA (US); Mostafa KHOSHNEVISAN, San Diego, CA (US); Diana MAAMARI, San Diego, CA (US)

(21) Appl. No.: 18/976,284

(22) Filed: Dec. 10, 2024

(51) Int. Cl. H04L 5/00; H04L 27/26; H04W 72/23

(52) U.S. Cl. CPC H04L 5/0005; H04L 27/261; H04W 72/23

(57) ABSTRACT

A method for wireless communication at a user equipment (UE) and related apparatus are provided. In the method, the UE receives a physical downlink control channel (PDCCH) transmission in a control resource set (CORESET) spanning multiple symbols from a network entity. The PDCCH transmission includes multiple demodulation reference signals (DMRS) and has a DMRS pattern based on the duration of the CORESET. The DMRS pattern is in at least one of the time domain or the frequency domain. The UE further performs a channel estimation based on the DMRS.

### TECHNICAL FIELD

The present disclosure relates generally to communication systems and, more particularly, to the transmission of demodulation reference signals (DMRS) in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor may be configured to receive, from a network entity, a physical downlink control channel (PDCCH) transmission in a control resource set (CORESET) spanning multiple symbols, where the PDCCH transmission includes multiple demodulation reference signals (DMRS) having a DMRS pattern based on a duration of the CORESET, where the DMRS pattern is in at least one of a time domain or a frequency domain; and perform a channel estimation based on the DMRS.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor may be configured to transmit, to a UE, a PDCCH transmission in a CORESET spanning multiple symbols, where the PDCCH transmission includes multiple DMRS having a DMRS pattern based on a duration of the CORESET, where the DMRS pattern is in at least one of a time domain or a frequency domain; and communicate with the UE based on the DMRS.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating a demodulation reference signals (DMRS) pattern in a long control resource set (CORESET) in accordance with various aspects of the present disclosure.

FIG. 4B is a diagram illustrating another DMRS pattern in a long CORESET in accordance with various aspects of the present disclosure.

FIG. 5 is a diagram illustrating an example of a wireless communication method in accordance with various aspects of the present disclosure.

FIG. 6 is a call flow diagram illustrating a method of wireless communication in accordance with various aspects of the present disclosure.

FIG. 7 is a flowchart illustrating methods of wireless communication at a UE in accordance with various aspects of the present disclosure.

FIG. 8 is a flowchart illustrating methods of wireless communication at a UE in accordance with various aspects of the present disclosure.

FIG. 9 is a flowchart illustrating methods of wireless communication at a network entity in accordance with various aspects of the present disclosure.

FIG. 10 is a flowchart illustrating methods of wireless communication at a network entity in accordance with various aspects of the present disclosure.

FIG. 11 is a diagram illustrating an example of a hardware implementation for an example apparatus and/or UE.

FIG. 12 is a diagram illustrating an example of a hardware implementation for an example network entity.

### DETAILED DESCRIPTION

In wireless communication, demodulation reference signals (DMRS) are reference signals that can be used for various tasks, including channel estimation, signal demodulation, and timing and frequency synchronization. A control resource set (CORESET) includes a set of resources in the time and frequency domain for transmitting and receiving control information, such as the physical downlink control channel (PDCCH). The duration of a CORESET may be configured through radio resource control (RRC) signaling and can be up to three symbols, such as orthogonal frequency division multiplexing (OFDM) symbols. The DMRS in a CORESET may be used to facilitate the detection and decoding of the PDCCH in the CORESET. Within a CORESET, the DMRS may be uniformly distributed within the time or frequency domain resources. For example, the DMRS for a physical downlink control channel (PDCCH) transmission may be mapped across all resource element groups (REGs) on every symbol in a CORESET for a given PDCCH candidate, and the density of the DMRS in the frequency domain (e.g., the ratio of the number of resource elements (REs) used for the DMRS transmissions to the total number of REs in an OFDM symbol) may be a fixed value (e.g., 25%) for various durations of a CORESET. A longer CORESET (e.g., more than three OFDM symbols) can enhance network capacity and coverage. However, maintaining the current DMRS pattern in a long CORESET does not necessarily provide additional benefits for channel estimation but instead can result in higher overhead. Example aspects presented herein provide methods and apparatus for supporting a long CORESET (e.g., a CORESET spanning six symbols) with a cluster-based time domain DMRS pattern. Example aspects also provide signaling mechanisms to configure a user equipment (UE) with details of the DMRS pattern such as the number of clusters and the frequency domain density of the DMRS REs for each cluster.

Various aspects relate generally to wireless communication. Some aspects more specifically relate to the DMRS pattern in a CORESET. In some examples, a UE receives a PDCCH transmission in a CORESET spanning multiple symbols from a network entity. The PDCCH transmission includes multiple DMRS having a DMRS pattern based on the duration of the CORESET, and the DMRS pattern is in at least one of the time domain or the frequency domain. The UE further performs a channel estimation based on the DMRS. In some aspects, the CORESET may be a long CORESET that spans more than three symbols. In some examples, the DMRS pattern may include multiple DMRS clusters in the time domain, and at least two DMRS clusters of the multiple DMRS clusters may be separated by one or more symbols in the CORESET that contain no DMRS transmissions. In some examples, the at least two DMRS clusters may have the same DMRS density in the frequency domain. In some examples, the at least two DMRS clusters may have different DMRS density in the frequency domain. For example, the DMRS density in an earlier DMRS cluster may be an integer multiple, such as double or triple, of the DMRS density in a later DMRS cluster. In some examples, the UE may receive a CORESET configuration indicating the DMRS pattern from the network entity via radio resource control (RRC) signaling.

Particular aspects of the subject matter described in this disclosure can be implemented to realize one or more of the following potential advantages. In some examples, by providing a cluster-based DMRS pattern for a long CORESET, where the DMRS is concentrated at the beginning and end of CORESET symbols, the described techniques can be used to reduce unnecessary repetition of DMRS across all CORESET symbols, thereby minimizing the overhead and improving the efficiency of resource allocations in wireless communication. In some examples, by varying the DMRS density across the DMRS clusters within the CORESET (e.g., the DMRS density of an earlier cluster is an integer multiple of that in a later cluster), the described techniques allow for possible early termination of PDCCH decoding if the DMRS is not detected, thereby reducing power consumption without degrading channel estimation performance.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

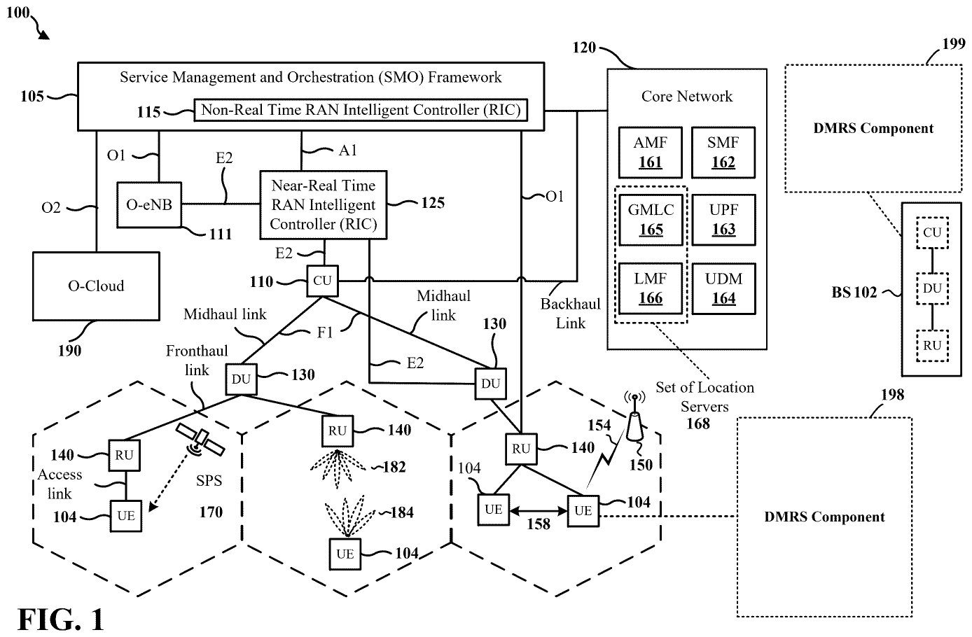

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the DMRS component 198. The DMRS component 198 may be configured to receive, from a network entity, a PDCCH transmission in a CORESET spanning multiple symbols, where the PDCCH transmission includes multiple DMRS having a DMRS pattern based on a duration of the CORESET, where the DMRS pattern is in at least one of a time domain or a frequency domain; and perform a channel estimation based on the DMRS. In certain aspects, the base station 102 may include the DMRS component 199. The DMRS component 199 may be configured to transmit, to a UE, a PDCCH transmission in a CORESET spanning multiple symbols, where the PDCCH transmission includes multiple DMRS having a DMRS pattern based on a duration of the CORESET, where the DMRS pattern is in at least one of a time domain or a frequency domain; and communicate with the UE based on the DMRS. Although the following description may be focused on 5G NR, the concepts described herein may be applicable to other similar areas, such as LTE, LTE-A, CDMA, GSM, and other wireless technologies.

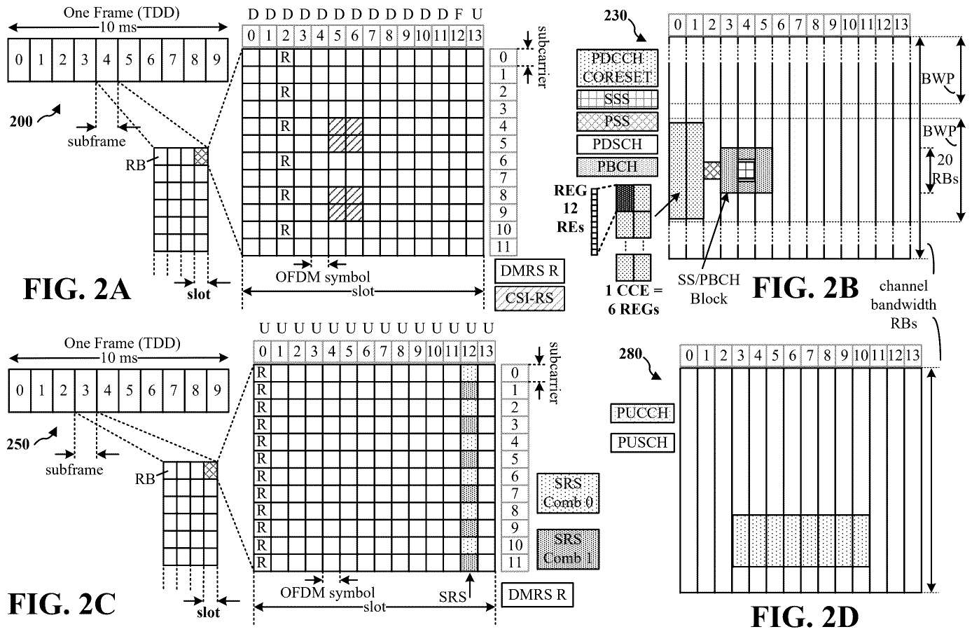

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

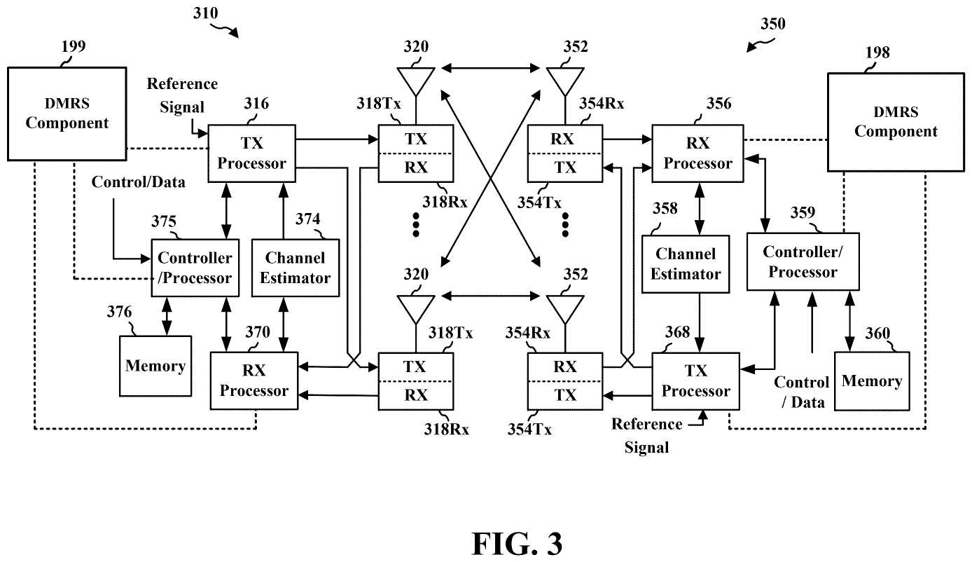

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the DMRS component 198 of FIG. 1.

At least one of the TX processor 316, the RX processor 370, and the controller/processor 375 may be configured to perform aspects in connection with the DMRS component 199 of FIG. 1.

In wireless communication, DMRS are reference signals that can be used for various tasks, including channel estimation, signal demodulation, and timing and frequency synchronization. A CORESET includes a set of resources in the time and frequency domain for transmitting and receiving control information, such as the physical downlink control channel (PDCCH). The duration of a CORESET (e.g., the number of symbols a CORESET spans or includes) may be configured through RRC signaling and can be up to three symbols (e.g., OFDM symbols). The DMRS in a CORESET may be used to facilitate the detection and decoding of the PDCCH in the CORESET. Within a CORESET, the DMRS may be uniformly distributed within the time or frequency domain resources. For example, the DMRS for a PDCCH transmission may be mapped across all REGs on every symbol in a CORESET for a given PDCCH candidate, and the density of the DMRS in the frequency domain may be a fixed value (e.g., 25%) for various durations of a CORESET. A longer CORESET (e.g., more than three OFDM symbols) can enhance network capacity and coverage. However, maintaining the current DMRS pattern in a long CORESET does not necessarily provide additional benefits for channel estimation but instead can result in higher overhead. Example aspects presented herein provide methods and apparatus for supporting a long CORESET (e.g., a CORESET spanning more than three symbols) with a cluster-based time domain DMRS pattern. Example aspects further provide signaling mechanisms to configure a UE with details of the DMRS pattern, such as the number of clusters and the frequency domain density of the DMRS REs for each cluster.

In wireless communication, such as wireless communications in 5G networks, the duration of a CORESET (e.g., the number of symbols a CORESET spans or includes) may be configured through Radio Resource Control (RRC) and can be up to three symbols (e.g., OFDM symbols). In some examples, the length of the CORESET may impact the scheduling timeline, such as the number of time slots between PDCCH/downlink control information (DCI) and physical downlink shared channel (PDSCH) transmission (e.g., K0), the number of time slots between PDSCH and hybrid automatic repeat request (HARQ) acknowledgment (ACK)/negative acknowledgment (NACK) transmissions (e.g., K1), and the number of time slots between PDCCH/DCI and physical uplink shared channel (PUSCH) transmissions (e.g., K2). In wireless communication, such as wireless communications in 5G networks, the density of the DMRS within the CORESET in the frequency domain may be fixed (e.g., at 25%) regardless of the varying durations a CORESET may have, and DMRS signals may be present in every symbol of the CORESET. As used herein, the density of the DMRS (or DMRS density) in the frequency domain may reflect the distribution of DMRS across the frequency resources allocated for a transmission. In some examples, the density of the DMRS may be represented by the ratio of the number of REs used for the DMRS transmissions to the total number of REs in a symbol (e.g., an OFDM symbol).

The DMRS may be used for two purposes with respect to the PDCCH transmissions. First, the DMRS may facilitate the detection of possible early termination of PDCCH decoding, which may help the UE to conserve power by not decoding PDCCH candidates within search space sets where the UE did not detect the DMRS. Secondly, DMRS may assist in channel estimation for the PDCCH. The consistent or uniform frequency density of the DMRS across all the symbols a CORESET spans or includes, which may be referred to as “CORESET symbols,” may reduce the complexity of the channel estimation process.

In some examples, a CORESET may extend beyond three symbols, which may be referred to as a “long CORESET.” A long CORESET that spans more than three symbols may enhance network capacity and coverage. For example, a long CORESET may facilitate time division duplexing (TDD) in mid-band frequencies and facilitate cross-carrier scheduling with frequency-selective implementation (xCC/FSI), with control information transmitted on lower bands. In some examples, a long CORESET may support larger aggregation levels (e.g., the number of REGs used to formulate a PDCCH candidate), accommodating more UEs that operate with these larger aggregation levels (ALs). This capability may facilitate the adoption of low power wide area (LPWA) devices and enhanced mobile broadband (EMBB) or extended reality (XR) devices that may be operating in low-power modes.

In the current configurations of the DMRS pattern (e.g., the distributions of the DMRS resources in the time or frequency domain), each CORESET symbol may include DMRS, with a consistent DMRS density in the frequency domain across all the CORESET symbols. However, with a longer CORESET (e.g., a CORESET that spans six symbols), incorporating the DMRS in every CORESET symbol (and multiplexing DMRS and DCI in every CORESET symbol) does not necessarily yield additional benefits for channel estimation compared to shorter CORESET (e.g., a CORESET that spans three symbols). On the other hand, multiplexing DMRS in all the CORESET symbols may lead to higher overhead and adversely impact the efficiency of wireless communication. To maintain the same code rate for a particular aggregation level (AI) with an increased CORESET duration, without compromising the effectiveness of channel estimation, it may be necessary to reduce the DMRS density in the frequency domain or adjust the DMRS pattern in the time domain. Example aspects presented herein provide methods and apparatus for supporting a long CORESET (e.g., a CORESET spanning six symbols) with a cluster-based time domain DMRS pattern and the signaling mechanisms to configure a UE with details of the DMRS pattern, including the number of clusters and the frequency domain density of the DMRS REs for each cluster. These approaches consider the impact of reducing the DMRS density in the frequency domain on the channel estimation performance, particularly in channels with a relatively high delay spread (e.g., the difference in arrival times between the fastest and slowest multipath signals at the receiver after the transmission of a single).

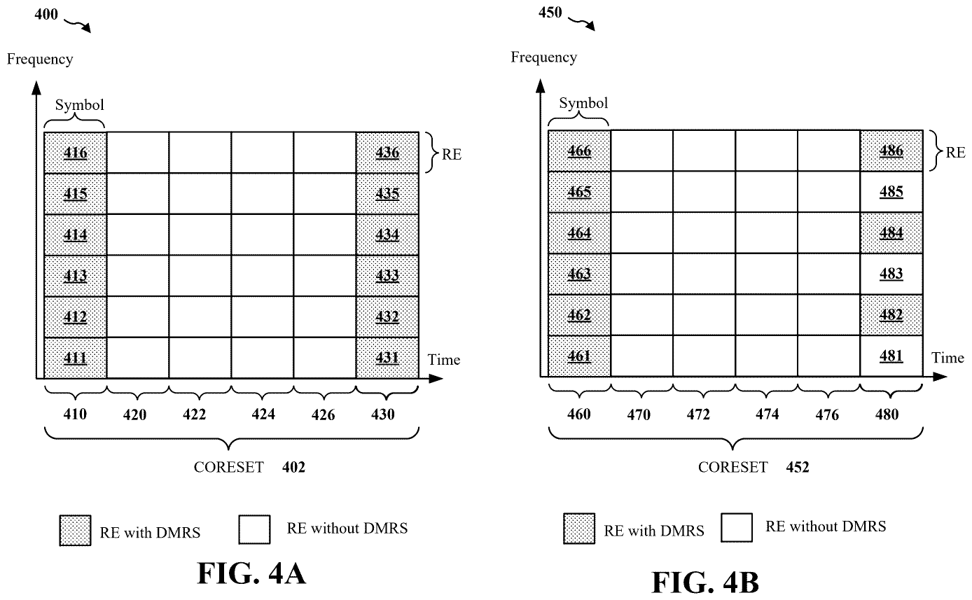

In some aspects, to achieve a balance between the early detection of PDCCH and a good channel estimation performance, the DMRS pattern in the time domain in a long CORESET (e.g., a CORESET that spans more than three symbols) may follow a cluster based DMRS distribution. FIG. 4A is a diagram 400 illustrating a DMRS pattern in a long CORESET in accordance with various aspects of the present disclosure. As shown in FIG. 4A, in some examples, a CORESET 402 may be a long CORESET and may span (or include) six CORESET symbols, such as symbols 410, 420, 422, 424, 426, and 430. In some examples, the first one or more symbols at the beginning of the CORESET 402 (e.g., the first symbol 410) may contain DMRS with a constant DMRS density in the frequency domain, and the last one or more symbols at the end of the CORESET 402 (e.g., the last symbol 430) may contain DMRS with a constant DMRS density in the frequency domain. For example, in the CORESET 402, the DMRS may be present in RE 411, 412, 413, 414, 415, 416 in the first symbol 410 and in RE 431, 432, 433, 434, 435, 436 in the last symbol 430. The one or more continuous symbols that contain DMRS may be referred to as a “DMRS cluster.” In the example in FIG. 4A, the DMRS density in the first DMRS cluster (containing symbol 410) may be the same as the DMRS density in the last DMRS cluster (containing symbol 430). In some aspects, the DMRS clusters at the beginning and at the end of the CORESET (e.g., CORESET 402) may be separated by at least one CORESET symbol (e.g., symbols 420, 422, 424, or 426) that contains no DMRS. This DMRS pattern ensures that DMRS is concentrated where needed, thereby reducing redundancy and potentially lowering overhead.

FIG. 4B is a diagram 450 illustrating a DMRS pattern in a long CORESET in accordance with various aspects of the present disclosure. As shown in FIG. 4B, a CORESET 452 may be a long CORESET and may span (or include) six CORESET symbols, such as symbols 460, 470, 472, 474, 476, and 480. In some examples, the first DMRS cluster containing one or more symbols (e.g., the first symbol 460) at the beginning of the CORESET 452 may contain DMRS with a constant DMRS density across these one or more symbols (e.g., the first symbol 460) in the frequency domain, and the last DMRS cluster containing one or more symbols (e.g., the last symbol 480) at the end of the CORESET 452 may contain DMRS with a constant DMRS density across these one or more symbols (e.g., the last symbol 480) in the frequency domain. In some aspects, the DMRS clusters at the beginning and at the end of the CORESET (e.g., CORESET 452) may be separated by at least one CORESET symbol (e.g., symbols 470, 472, 474, or 476) that contains no DMRS. In the example in FIG. 4B, the DMRS density in the first DMRS cluster (containing symbol 460) may be different from the DMRS density in the last DMRS cluster (containing symbol 480). In some examples, the DMRS density in the first DMRS cluster (containing symbol 460) may be an integer multiple of the DMRS density in the last DMRS cluster (containing symbol 480). For example, in CORESET 452, the DMRS is present in RE 461, 462, 463, 464, 465, 466 in the first DMRS cluster and in RE 482, 484, and 486 (but not present in RE 481, 483, 485) in the last DMRS cluster. Hence, the DMRS density (e.g., 1) in the first DMRS cluster (including symbol 460) is twice the DMRS density (e.g., ½) in the last DMRS cluster (including symbol 480).

In some examples, a long CORESET may include more than two DMRS clusters (e.g., three or more DMRS clusters), and adjacent DMRS clusters may be separated by one or more CORESET symbols that contain no DMRS. In some examples, the DMRS density in the frequency domain may be the same across all three or more DMRS clusters. In some examples, the DMRS density in the frequency domain may be different for at least two DMRS clusters of the three or more DMRS clusters. For example, the earlier DMRS cluster may have a DMRS density that is an integer multiple of the DMRS density of the later DMRS cluster.

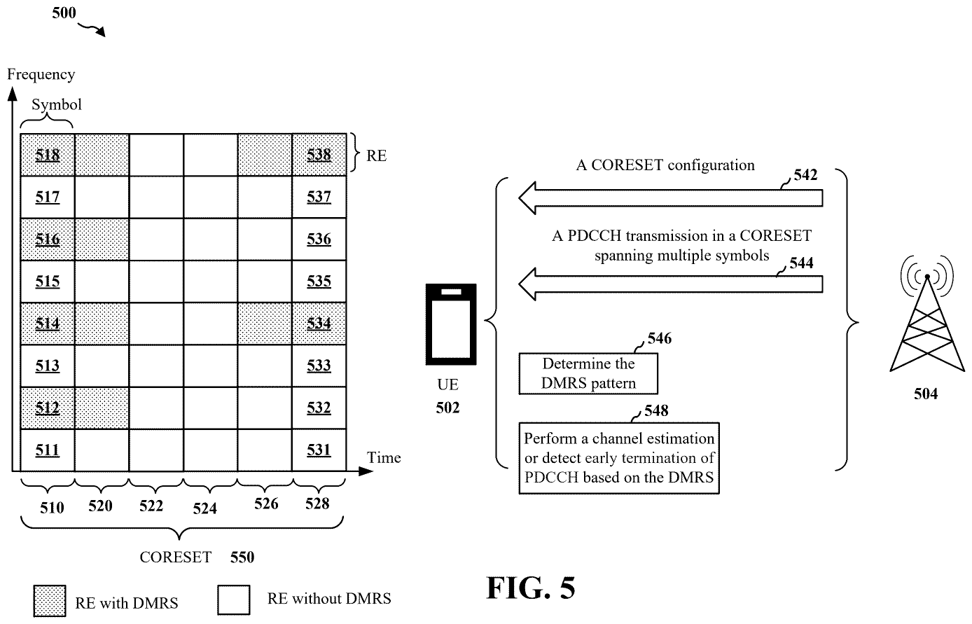

FIG. 5 is a diagram 500 illustrating an example of a wireless communication method in accordance with various aspects of the present disclosure. As shown in FIG. 5, the base station 504 may transmit a CORESET configuration to UE 502 at 542. Following the CORESET configuration, the base station 504 may further transmit a PDCCH transmission with a long CORESET 550 for UE 502 at 544. In some aspects, the PDCCH with a long CORESET 550 may be configured with a cluster-based time domain DMRS pattern. For example, the DMRS may be distributed at the one or more symbols at the beginning (e.g., symbols 510, 520) and one or more symbols at the end (e.g., symbols 526, 528) of the CORESET 550, while the DMRS-containing symbols at the beginning and the end of the CORESET may be separated by at least one symbol (e.g., symbols 522, 524) that does not contain DMRS in the CORESET 550.

In some aspects, the DMRS density in the frequency domain across these DMRS clusters may be the same. For example, as shown in FIG. 4A, the DMRS density in the first DMRS cluster (including symbol 410) may be the same as the DMRS density in the last DMRS cluster (including symbol 430). In some examples, the DMRS density in the frequency domain in an earlier DMRS cluster may be different from and be an integer multiple (e.g., twice or triple) of the DMRS density in a later DMRS cluster. For example, as shown in FIG. 4B, the DMRS density in the frequency domain in the first DMRS cluster (including symbol 460) may be twice the DMRS density in the last DMRS cluster (including symbol 480). For example, as shown in FIG. 5, the DMRS density in the frequency domain in the first DMRS cluster (including symbols 510, 520) may be twice the DMRS density in the last DMRS cluster (including symbols 526, 528). For example, the varying DMRS density may allow the implantation of a comb 2 pattern (e.g., one out of every two RE contains DMRS) in the first DMRS cluster (e.g., at symbols 510, 520) and a comb 4 pattern (e.g., one out of every four RE contains DMRS) in subsequent DMRS clusters (e.g., at symbols 526, 528). For example, in symbol 510 in the first DMRS cluster, RE 512, 514, 516, and 518 may contain DMRS, while RE 511, 513, 515, and 517 may not contain DMRS, thereby forming a comb 2 pattern in symbol 510. In symbol 528 in the last DMRS cluster, RE 534, 538, may contain DMRS, while RE 531, 532, 533, 535, 536, 537 may not contain DMRS, thereby forming a comb 4 pattern in symbol 528. In some examples, the varying DMRS density may help to reduce channel estimation complexity and improve DMRS detection performance.

In some aspects, the time domain DMRS pattern for the long CORESET 550 may be included as part of the CORESET configuration parameters and may be signaled via RRC (e.g., at 542). For example, details of the DMRS pattern in CORESET 550, including the number of DMRS clusters (e.g., two DMRS clusters for CORESET 550) and the DMRS density in the frequency domain for each DMRS cluster, may be included in a CORESET configuration and be signaled through RRC signaling (e.g., at 542). In some aspects, the DMRS pattern in the time domain or the frequency domain (or both) for a long CORESET may be predetermined based on the CORESET (e.g., the length of the CORESET). For example, the time domain DMRS pattern corresponding to a CORESET of a specific length (or duration) may be predetermined in advance in a wireless communication standard. Then, based on an index of a CORESET, the UE 502 may, at 546, determine the DMRS pattern (in time or frequency domain) for the CORESET based on a mapping relationship between the CORESET indices and the DMRS patterns. In some examples, the base station 504 may determine the DMRS pattern (in time or frequency domain) for the CORESET based on the mapping relationship between the CORESET indices and the DMRS patterns. As an example, with a predetermined mapping relationship specifies that CORESET #0 always uses two DMRS clusters with a comb 2 frequency pattern, the UE 502 (or the base station 504) may determine that the DMRS clusters in a received CORESET follow a comb 2 frequency pattern if the received CORESET is CORESET #0.

At 548, the UE 502 may perform the channel estimation or detect possible early termination of PDCCH transmissions based on the DMRS (e.g., the DMRS in CORESET 550).

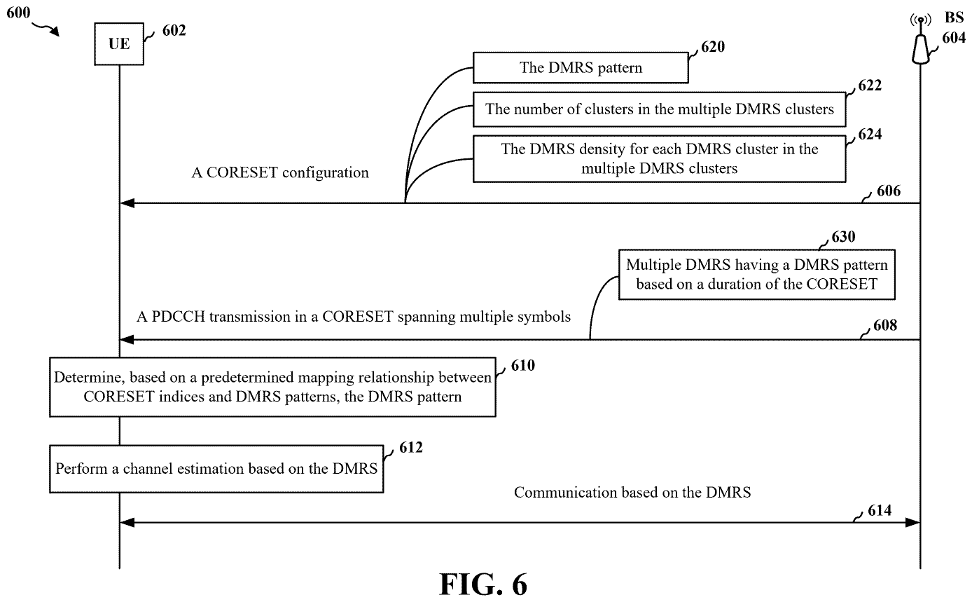

FIG. 6 is a call flow diagram 600 illustrating a method of wireless communication in accordance with various aspects of this present disclosure. Various aspects are described in connection with a UE 602 and a base station 604. The aspects may be performed by the UE 602 or the base station 604 in aggregation and/or by one or more components of a base station 604 (e.g., a CU 110, a DU 130, and/or an RU 140).

As shown in FIG. 6, at 606, the UE 602 may receive a CORESET configuration from the base station 604. In some examples, the CORESET configuration may indicate the DMRS pattern 620 in a PDCCH transmission in a CORESET.

In some examples, the DMRS pattern may include multiple DMRS clusters in the time domain, and at least two DMRS clusters of the multiple DMRS clusters may be separated by one or more symbols that contain no DMRS transmissions. For example, referring to FIG. 4A, in CORESET 402, the DMRS pattern may include the first DMRS cluster (including symbol 410) and the second DMRS (including symbol 430) in the time domain, and the first and the second DMRS clusters may be separated by one or more symbols that contain no DMRS transmissions, such as symbols 420, 422, 424, 426 in CORESET 402. Referring to FIG. 5, in CORESET 550, the DMRS pattern may include the first DMRS cluster (including symbols 510, 520) and the second DMRS (including symbols 526, 528) in the time domain, and the first and the second DMRS clusters may be separated by one or more symbols that contain no DMRS transmissions, such as symbols 522, 524 in CORESET 550.

In some examples, the at least two DMRS clusters in the multiple DMRS clusters may have the same DMRS density in the frequency domain. For example, in FIG. 4A, the first DMRS cluster (including symbol 410) and the second DMRS (including symbol 430) may have the same DMRS density in the frequency domain.

In some examples, the at least two DMRS clusters in the multiple DMRS clusters may have different DMRS densities in the frequency domain. For example, the first DMRS cluster may have the first DMRS density that is different from the second DMRS density of the second DMRS cluster, which may be located after the first DMRS cluster. In some examples, the first DMRS density may be an integer multiple, such as double or triple, of the second DMRS density. In some examples, the first DMRS density may be an integer multiple, such as double or triple, of the second DMRS density. For example, referring to FIG. 5, the first DMRS cluster (including symbols 510, 520) may have a comb 2 pattern for DMRS in the frequency domain (meaning one out of every two REs in the symbol, such as symbol 510, contains DMRS), while the second DMRS cluster (including symbols 526, 528) may have a comb 4 pattern for DMRS in the frequency domain (meaning one out of every four REs in the symbol, such as symbol 528, contains DMRS). The first DMRS cluster (including symbols 510, 520) may have a DMRS density that is twice the DMRS density for the second DMRS cluster (including symbols 526, 528) in the frequency domain.

In some examples, the CORESET configuration (e.g., at 606) may further include one or more of: the number of clusters in the multiple DMRS clusters (e.g., two DMRS clusters for CORESET 550), or the DMRS density for each DMRS cluster in the multiple DMRS clusters (e.g., a comb 2 DMRS pattern for the first DMRS cluster that includes symbols 510, 520, and a comb 4 DMRS pattern for the second DMRS cluster that includes symbols 526, 528).

In some examples, the DMRS pattern may be associated with a CORESET index of the CORESET (e.g., at 608). For example, a CORESET with a specific length (which may be identified based on the CORESET index) may be associated with a specific DMRS pattern in the time domain or the frequency domain, or both. For example, CORESET #0 may be associated with a DMRS pattern that includes two DMRS clusters in the time domain, and each DMRS cluster may have a comb 2 pattern in the frequency domain.

At 608, a UE 602 may receive a PDCCH transmission in a CORESET from the base station 604. The CORESET may span multiple symbols. For example, the symbols may be OFDM symbols. In some examples, as shown in 630, the PDCCH transmission may include multiple DMRS having a DMRS pattern based on the duration of the CORESET (e.g., the number of symbols in the CORESET). In some examples, the DMRS pattern may be in the time domain or the frequency domain, or both. For example, referring to FIG. 4A, the CORESET 402 may span six symbols (e.g., symbols 410, 420, 422, 424, 426, 430). These symbols may have a DMRS pattern that includes two DMRS clusters at the beginning (e.g., at symbol 410) and the end (e.g., at symbol 430) of the CORESET 402.

In some examples, at 610, the UE 602 may determine the DMRS pattern based on a predetermined mapping relationship between CORESET indices and DMRS patterns.

At 612, the UE 602 may perform the channel estimation for the channel between the UE 602 and the base station 604 based on the DMRS (e.g., the DMRS in the PDCCH transmission in 608).

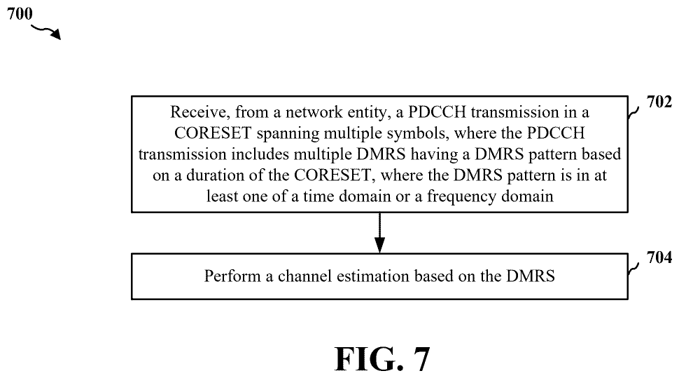

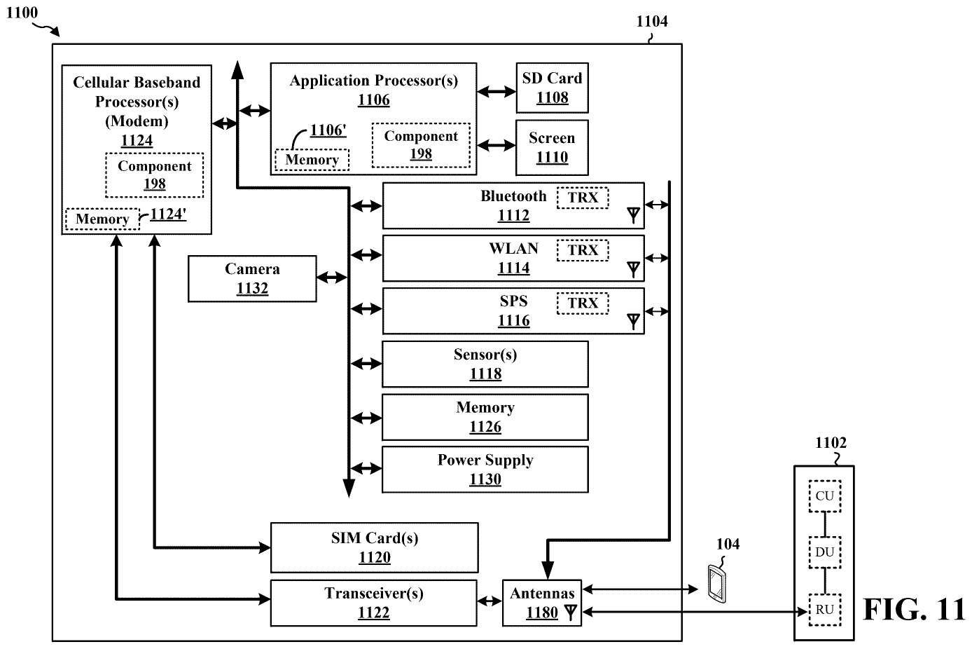

FIG. 7 is a flowchart 700 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 504, 604; or the network entity 1102 in the hardware implementation of FIG. 11). The UE may be the UE 104, 350, 502, 602, or the apparatus 1104 in the hardware implementation of FIG. 11. By providing a cluster-based DMRS pattern for a long CORESET, where the DMRS is concentrated at the beginning and end of CORESET symbols, the methods reduce unnecessary repetition of DMRS across all CORESET symbols, thereby minimizing the overhead and improving the efficiency of resource allocations in wireless communication. Additionally, by varying the DMRS density across the DMRS clusters within the CORESET (e.g., the DMRS density of an earlier cluster is an integer multiple of that in a later cluster), the methods allow for possible early termination of PDCCH decoding if the DMRS is not detected, thereby reducing power consumption without degrading channel estimation performance.

As shown in FIG. 7, at 702, the UE may receive, from a network entity, a PDCCH transmission in a CORESET spanning multiple symbols (e.g., OFDM symbols). The PDCCH transmission may include multiple DMRS having a DMRS pattern based on a duration of the CORESET. The DMRS pattern may be in at least one of the time domain or the frequency domain. FIG. 4A, FIG. 4B, FIG. 5, and FIG. 6 illustrate various aspects of the steps in connection with flowchart 700. For example, referring to FIG. 6, the UE 602 may, at 608, receive from a network entity (e.g., base station 604) a PDCCH transmission in a CORESET spanning multiple symbols. Referring to FIG. 4A, the CORESET 402 may span six symbols (e.g., symbols 410, 420, 422, 424, 426, 430). The PDCCH transmission may include multiple DMRS (e.g., DMRS in symbol 410 and symbol 430) having a DMRS pattern based on a duration of the CORESET. The DMRS pattern may be in at least one of the time domain or the frequency domain. In some aspects, 702 may be performed by the DMRS component 198.

At 704, the UE may perform a channel estimation based on the DMRS. For example, referring to FIG. 5, the UE 502 may, at 548, perform a channel estimation based on the DMRS. Referring to FIG. 6, the UE 602 may, at 612, perform a channel estimation based on the DMRS. In some aspects, 704 may be performed by the DMRS component 198.

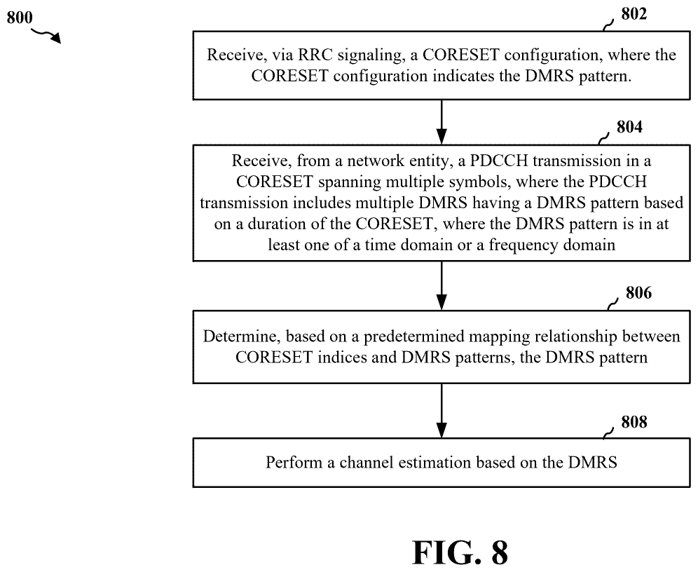

FIG. 8 is a flowchart 800 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 504, 604; or the network entity 1102 in the hardware implementation of FIG. 11). The UE may be the UE 104, 350, 502, 602, or the apparatus 1104 in the hardware implementation of FIG. 11. By providing a cluster-based DMRS pattern for a long CORESET, where the DMRS is concentrated at the beginning and end of CORESET symbols, the methods reduce unnecessary repetition of DMRS across all CORESET symbols, thereby minimizing the overhead and improving the efficiency of resource allocations in wireless communication. Additionally, by varying the DMRS density across the DMRS clusters within the CORESET (e.g., the DMRS density of an earlier cluster is an integer multiple of that in a later cluster), the methods allow for possible early termination of PDCCH decoding if the DMRS is not detected, thereby reducing power consumption without degrading channel estimation performance.

As shown in FIG. 8, at 804, the UE may receive, from a network entity, a PDCCH transmission in a CORESET spanning multiple symbols (e.g., OFDM symbols). The PDCCH transmission may include multiple DMRS having a DMRS pattern based on a duration of the CORESET. The DMRS pattern may be in at least one of the time domain or the frequency domain. FIG. 4A, FIG. 4B, FIG. 5, and FIG. 6 illustrate various aspects of the steps in connection with flowchart 800. For example, referring to FIG. 6, the UE 602 may, at 608, receive from a network entity (e.g., base station 604) a PDCCH transmission in a CORESET spanning multiple symbols. Referring to FIG. 4A, the CORESET 402 may span six symbols (e.g., symbols 410, 420, 422, 424, 426, 430). The PDCCH transmission may include multiple DMRS (e.g., DMRS in symbol 410 and symbol 430) having a DMRS pattern based on a duration of the CORESET. The DMRS pattern may be in at least one of the time domain or the frequency domain. In some aspects, 804 may be performed by the DMRS component 198.

At 808, the UE may perform a channel estimation based on the DMRS. For example, referring to FIG. 5, the UE 502 may, at 548, perform a channel estimation based on the DMRS. Referring to FIG. 6, the UE 602 may, at 612, perform a channel estimation based on the DMRS. In some aspects, 808 may be performed by the DMRS component 198.

In some aspects, the multiple symbols in the CORESET may include more than three symbols. For example, referring to FIG. 4B, the multiple symbols in the CORESET 452 may include six symbols (e.g., symbols 460, 470, 472, 474, 476, 480).

In some aspects, the DMRS pattern may include multiple DMRS clusters in the time domain, and at least two DMRS clusters of the multiple DMRS clusters may be separated by one or more symbols that contain no DMRS transmissions. For example, referring to FIG. 5, the DMRS pattern in CORESET 550 may include two DMRS clusters (e.g., the first DMRS cluster that includes symbols 510, 520, and the second DMRS cluster that includes symbols 526, 528) in the time domain. At least two DMRS clusters of the multiple DMRS clusters (e.g., the first DMRS cluster and the second DMRS cluster) may be separated by one or more symbols (e.g., symbols 522, 524 in CORESET 550) that contain no DMRS transmissions.

In some aspects, the at least two DMRS clusters may have the same DMRS density in the frequency domain. For example, referring to FIG. 4A, the two DMRS clusters (e.g., the first DMRS cluster that includes symbol 410 and the second DMRS cluster that includes symbol 430) may have the same DMRS density (e.g., 1) in the frequency domain.

In some aspects, the at least two DMRS clusters may include an earlier DMRS cluster and a later DMRS cluster located after the earlier DMRS cluster. The earlier DMRS cluster may have a first DMRS density in the frequency domain, and the later DMRS cluster has a second DMRS density in the frequency domain. The first DMRS density may be different from the second DMRS density and may be an integer multiple of the second DMRS density. For example, referring to FIG. 5, the DMRS density (e.g., ½) of an earlier DMRS cluster (e.g., the DMRS cluster that includes symbols 510, 520) may be twice the DMRS density (e.g., ¼) in a later DMRS cluster (e.g., the DMRS cluster that includes symbols 526, 528).

In some aspects, the at least two DMRS clusters may include a first DMRS cluster including at least one symbol at the beginning of the CORESET and a second DMRS cluster including at least one symbol at the end of the CORESET. The first DMRS cluster may have a first DMRS density in the frequency domain across the at least one symbol in the first DMRS cluster, and the second DMRS cluster may have a second DMRS density in the frequency domain across the at least one symbol in the second DMRS cluster. For example, referring to FIG. 5, the at least two DMRS clusters may include a first DMRS cluster (e.g., the DMRS cluster that includes symbols 510, 520) including at least one symbol (e.g., symbols 510, 520) at the beginning of the CORESET 550 and a second DMRS cluster (e.g., the DMRS cluster that includes symbols 526, 528) including at least one symbol (e.g., symbols 526, 528) at the end of the CORESET 550. The first DMRS cluster may have a first DMRS density (e.g., the DMRS density of ½) in the frequency domain across the at least one symbol (e.g., symbols 510, 520) in the first DMRS cluster, and the second DMRS cluster may have a second DMRS density (e.g., DMRS density of ¼) in the frequency domain across the at least one symbol (e.g., symbols 526, 528) in the second DMRS cluster.

In some aspects, the first DMRS density may be equal to the second DMRS density. For example, referring to FIG. 4A, the first DMRS density (e.g., the DMRS density in the DMRS cluster that includes symbol 410) may be equal to the second DMRS density (e.g., the DMRS density in the DMRS cluster that includes symbol 430).

In some aspects, the first DMRS density may be different from the second DMRS density and may be an integer multiple of the second DMRS density. For example, referring to FIG. 5, the first DMRS density (the DMRS density of ½ in symbols 510, 520) may be twice the second DMRS density (the DMRS density of ¼ in symbols 526, 528).

In some aspects, at 802, the UE may receive, via RRC signaling, a CORESET configuration. The CORESET configuration may indicate the DMRS pattern. For example, referring to FIG. 6, the UE 602 may, at 606, receive, via RRC signaling, a CORESET configuration. The CORESET configuration may indicate the DMRS pattern (e.g., DMRS pattern in CORESET 550). In some aspects, 802 may be performed by the DMRS component 198.

In some aspects, the CORESET configuration may further include one or more of: the number of clusters in the multiple DMRS clusters, or the DMRS density for each DMRS cluster in the multiple DMRS clusters. For example, referring to FIG. 6, the CORESET configuration may further include one or more of: the number of clusters in the multiple DMRS clusters (e.g., at 622), or the DMRS density for each DMRS cluster in the multiple DMRS clusters (e.g., at 624). Referring to FIG. 5, the CORESET configuration (e.g., at 542) may include one or more of: the number of clusters (e.g., two clusters) in the multiple DMRS clusters, or the DMRS density for each DMRS cluster in the multiple DMRS clusters (e.g., the DMRS density of ½ for the first DMRS cluster that includes symbols 510, 520, and the DMRS density of ¼ for the second DMRS cluster that includes symbols 526, 528).

In some aspects, the DMRS pattern may be associated with a CORESET index. For example, referring to FIG. 6, the DMRS pattern (e.g., at 620) may be associated with a CORESET index of the CORESET.

In some aspects, at 806, the UE may determine the DMRS pattern based on a predetermined mapping relationship between CORESET indices and DMRS patterns. For example, referring to FIG. 5, the UE 502 may, at 546, determine the DMRS pattern based on a predetermined mapping relationship between CORESET indices and DMRS patterns. Referring to FIG. 6, the UE 602 may, at 610, determine the DMRS pattern based on a predetermined mapping relationship between CORESET indices and DMRS patterns. In some aspects, 806 may be performed by the DMRS component 198.

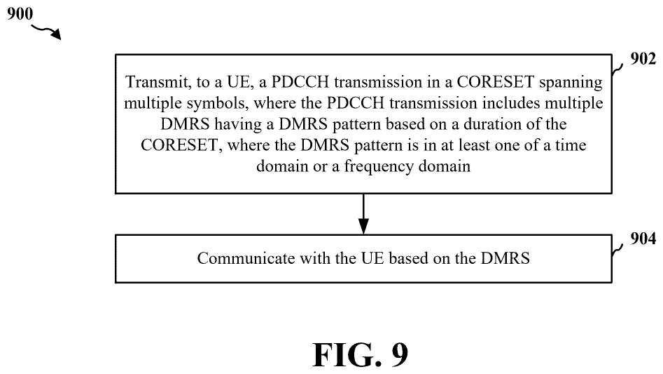

FIG. 9 is a flowchart 900 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 504, 604; or the network entity 1102 in the hardware implementation of FIG. 11). The UE may be the UE 104, 350, 502, 602, or the apparatus 1104 in the hardware implementation of FIG. 11. By providing a cluster-based DMRS pattern for a long CORESET, where the DMRS is concentrated at the beginning and end of CORESET symbols, the methods reduce unnecessary repetition of DMRS across all CORESET symbols, thereby minimizing the overhead and improving the efficiency of resource allocations in wireless communication. Additionally, by varying the DMRS density across the DMRS clusters within the CORESET (e.g., the DMRS density of an earlier cluster is an integer multiple of that in a later cluster), the methods allow for possible early termination of PDCCH decoding if the DMRS is not detected, thereby reducing power consumption without degrading channel estimation performance.

As shown in FIG. 9, at 902, the network entity may transmit, to a UE, a PDCCH transmission in a CORESET spanning multiple symbols (e.g., OFDM symbols). The PDCCH transmission may include multiple DMRS having a DMRS pattern based on a duration of the CORESET. The DMRS pattern may be in at least one of the time domain or the frequency domain. FIG. 4A, FIG. 4B, FIG. 5, and FIG. 6 illustrate various aspects of the steps in connection with flowchart 900. For example, referring to FIG. 6, the network entity (e.g., base station 604) may, at 608, transmit to a UE 602 a PDCCH transmission in a CORESET spanning multiple symbols (e.g., OFDM symbols). Referring to FIG. 5, a CORESET 550 may span six symbols (e.g., symbols 510, 520, 522, 524, 526, 528). The PDCCH transmission may include multiple DMRS (e.g., DMRS in symbols 510, 520 and DMRS in symbols 526, 528) having a DMRS pattern based on a duration of the CORESET. The DMRS pattern may be in at least one of the time domain or the frequency domain. In some aspects, 902 may be performed by the DMRS component 199.

At 904, the network entity may communicate with the UE based on the DMRS. For example, referring to FIG. 6, the network entity (e.g., base station 604) may, at 614, communicate with the UE 602 based on the DMRS. In some aspects, 904 may be performed by DMRS component 199.

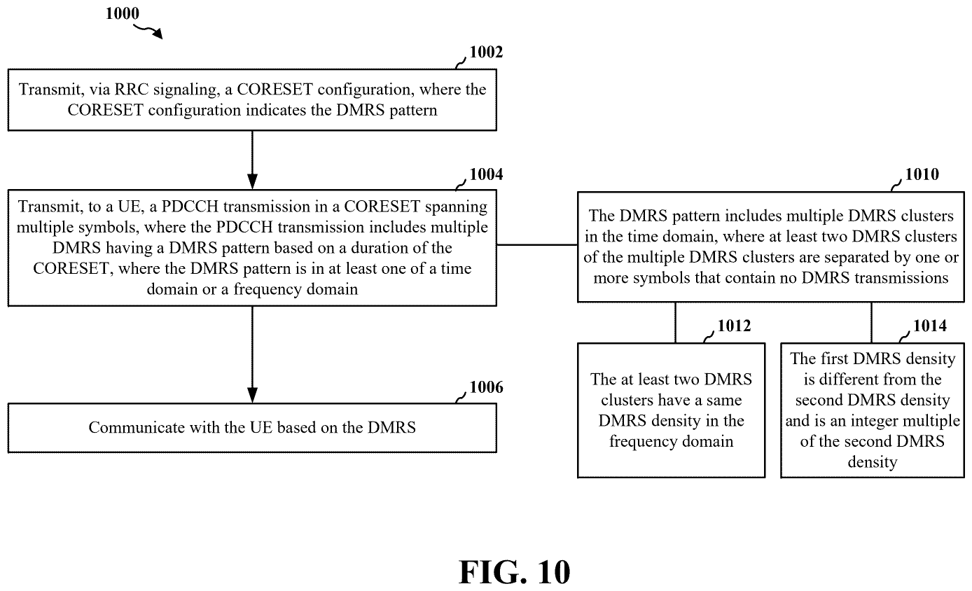

FIG. 10 is a flowchart 1000 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 504, 604; or the network entity 1102 in the hardware implementation of FIG. 11). The UE may be the UE 104, 350, 502, 602, or the apparatus 1104 in the hardware implementation of FIG. 11. By providing a cluster-based DMRS pattern for a long CORESET, where the DMRS is concentrated at the beginning and end of CORESET symbols, the methods reduce unnecessary repetition of DMRS across all CORESET symbols, thereby minimizing the overhead and improving the efficiency of resource allocations in wireless communication. Additionally, by varying the DMRS density across the DMRS clusters within the CORESET (e.g., the DMRS density of an earlier cluster is an integer multiple of that in a later cluster), the methods allow for possible early termination of PDCCH decoding if the DMRS is not detected, thereby reducing power consumption without degrading channel estimation performance.

As shown in FIG. 10, at 1004, the network entity may transmit, to a UE, a PDCCH transmission in a CORESET spanning multiple symbols (e.g., OFDM symbols). The PDCCH transmission may include multiple DMRS having a DMRS pattern based on a duration of the CORESET. The DMRS pattern may be in at least one of the time domain or the frequency domain. FIG. 4A, FIG. 4B, FIG. 5, and FIG. 6 illustrate various aspects of the steps in connection with flowchart 900. For example, referring to FIG. 6, the network entity (e.g., base station 604) may, at 608, transmit to a UE 602 a PDCCH transmission in a CORESET spanning multiple symbols (e.g., OFDM symbols). Referring to FIG. 5, a CORESET 550 may span six symbols (e.g., symbols 510, 520, 522, 524, 526, 528). The PDCCH transmission may include multiple DMRS (e.g., DMRS in symbols 510, 520 and DMRS in symbols 526, 528) having a DMRS pattern based on a duration of the CORESET. The DMRS pattern may be in at least one of the time domain or the frequency domain. In some aspects, 1004 may be performed by the DMRS component 199.

At 1006, the network entity may communicate with the UE based on the DMRS. For example, referring to FIG. 6, the network entity (e.g., base station 604) may, at 614, communicate with the UE 602 based on the DMRS. In some aspects, 1006 may be performed by DMRS component 199.

In some aspects, the multiple symbols may include more than three symbols. For example, referring to FIG. 4B, the multiple symbols in the CORESET 452 may include six symbols (e.g., symbols 460, 470, 472, 474, 476, 480).

In some aspects, the DMRS pattern may include multiple DMRS clusters in the time domain (e.g., 1010). At least two DMRS clusters of the multiple DMRS clusters may be separated by one or more symbols that contain no DMRS transmissions. For example, referring to FIG. 5, the DMRS pattern in CORESET 550 may include two DMRS clusters (e.g., the first DMRS cluster that includes symbols 510, 520, and the second DMRS cluster that includes symbols 526, 528) in the time domain. At least two DMRS clusters of the multiple DMRS clusters (e.g., the first DMRS cluster and the second DMRS cluster) may be separated by one or more symbols (e.g., symbols 522, 524 in CORESET 550) that contain no DMRS transmissions.

In some aspects, the at least two DMRS clusters may have the same DMRS density in the frequency domain (e.g., at 1012). For example, referring to FIG. FIG. 4A, the two DMRS clusters (e.g., the first DMRS cluster that includes symbol 410 and the second DMRS cluster that includes symbol 430) may have the same DMRS density (e.g., 1) in the frequency domain.

In some aspects, the at least two DMRS clusters may include an earlier DMRS cluster and a later DMRS cluster located after the earlier DMRS cluster. The earlier DMRS cluster may have a first DMRS density in the frequency domain, and the later DMRS cluster may have a second DMRS density in the frequency domain. The first DMRS density may be different from the second DMRS density and may be an integer multiple of the second DMRS density (e.g., at 1014). For example, referring to FIG. 5, the DMRS density (e.g., ½) of an earlier DMRS cluster (e.g., the DMRS cluster that includes symbols 510, 520) may be twice the DMRS density (e.g., ¼) in a later DMRS cluster (e.g., the DMRS cluster that includes symbols 526, 528).

In some aspects, the at least two DMRS clusters may include a first DMRS cluster including at least one symbol at the beginning of the CORESET and a second DMRS cluster including at least one symbol at the end of the CORESET. The first DMRS cluster may have a first DMRS density in the frequency domain across the at least one symbol in the first DMRS cluster, and the second DMRS cluster may have a second DMRS density in the frequency domain across the at least one symbol in the second DMRS cluster. For example, referring to FIG. 5, the at least two DMRS clusters may include a first DMRS cluster (e.g., the DMRS cluster that includes symbols 510, 520) including at least one symbol (e.g., symbols 510, 520) at the beginning of the CORESET 550 and a second DMRS cluster (e.g., the DMRS cluster that includes symbols 526, 528) including at least one symbol (e.g., symbols 526, 528) at the end of the CORESET 550. The first DMRS cluster may have a first DMRS density (e.g., the DMRS density of ½) in the frequency domain across the at least one symbol (e.g., symbols 510, 520) in the first DMRS cluster, and the second DMRS cluster may have a second DMRS density (e.g., DMRS density of ¼) in the frequency domain across the at least one symbol (e.g., symbols 526, 528) in the second DMRS cluster.

In some aspects, the first DMRS density may be equal to the second DMRS density. [0122] For example, referring to FIG. 4A, the first DMRS density (e.g., the DMRS density in the DMRS cluster that includes symbol 410) may be equal to the second DMRS density (e.g., the DMRS density in the DMRS cluster that includes symbol 430).

In some aspects, the first DMRS density may be different from the second DMRS density and may be an integer multiple of the second DMRS density. For example, referring to FIG. 5, the first DMRS density (the DMRS density of ½ in symbols 510, 520) may be twice the second DMRS density (the DMRS density of ¼ in symbols 526, 528).

In some aspects, at 1002, the network entity may transmit, via RRC signaling, a CORESET configuration. The CORESET configuration may indicate the DMRS pattern. For example, referring to FIG. 6, the network entity (e.g., base station 604) may, at 606, transmit, via RRC signaling, a CORESET configuration. The CORESET configuration may indicate the DMRS pattern (e.g., DMRS pattern in CORESET 550). In some aspects, 1002 may be performed by DMRS component 199.

In some aspects, the CORESET configuration may further include one or more of: the number of clusters in the multiple DMRS clusters, or the DMRS density for each DMRS cluster in the multiple DMRS clusters. For example, referring to FIG. 6, the CORESET configuration may further include one or more of: the number of clusters in the multiple DMRS clusters (e.g., at 622), or the DMRS density for each DMRS cluster in the multiple DMRS clusters (e.g., at 624). Referring to FIG. 5, the CORESET configuration (e.g., at 542) may include one or more of: the number of clusters (e.g., two clusters) in the multiple DMRS clusters, or the DMRS density for each DMRS cluster in the multiple DMRS clusters (e.g., the DMRS density of ½ for the first DMRS cluster that includes symbols 510, 520, and the DMRS density of ¼ for the second DMRS cluster that includes symbols 526, 528).

In some aspects, the DMRS pattern may be associated with a CORESET index. For example, referring to FIG. 6, the DMRS pattern (e.g., at 620) may be associated with a CORESET index of the CORESET.

In some aspects, the DMRS pattern may be based on a predetermined mapping relationship between CORESET indices and DMRS patterns. For example, referring to FIG. 6, the DMRS pattern (e.g., at 620) may be based on a predetermined mapping relationship between CORESET indices and DMRS patterns.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor (or processing circuitry) 1124 (also referred to as a modem) coupled to one or more transceivers 1122 (e.g., cellular RF transceiver). The cellular baseband processor(s) (or processing circuitry) 1124 may include at least one on-chip memory (or memory circuitry) 1124′. In some aspects, the apparatus 1104 may further include one or more subscriber identity modules (SIM) cards 1120 and at least one application processor (or processing circuitry) 1106 coupled to a secure digital (SD) card 1108 and a screen 1110. The application processor(s) (or processing circuitry) 1106 may include on-chip memory (or memory circuitry) 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) (or processing circuitry) 1124 communicates through the transceiver(s) 1122 via one or more antennas 1180 with the UE 104 and/or with an RU associated with a network entity 1102. The cellular baseband processor(s) (or processing circuitry) 1124 and the application processor(s) (or processing circuitry) 1106 may each include a computer-readable medium/memory (or memory circuitry) 1124′, 1106′, respectively. The additional memory modules 1126 may also be considered a computer-readable medium/memory (or memory circuitry). Each computer-readable medium/memory (or memory circuitry) 1124′, 1106′, 1126 may be non-transitory. The cellular baseband processor(s) (or processing circuitry) 1124 and the application processor(s) (or processing circuitry) 1106 are each responsible for general processing, including the execution of software stored on the computer-readable medium/memory (or memory circuitry). The software, when executed by the cellular baseband processor(s) (or processing circuitry) 1124/application processor(s) (or processing circuitry) 1106, causes the cellular baseband processor(s) (or processing circuitry) 1124/application processor(s) (or processing circuitry) 1106 to perform the various functions described supra. The cellular baseband processor(s) (or processing circuitry) 1124 and the application processor(s) (or processing circuitry) 1106 are configured to perform the various functions described supra based at least in part of the information stored in the memory (or memory circuitry). That is, the cellular baseband processor(s) (or processing circuitry) 1124 and the application processor(s) (or processing circuitry) 1106 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1124/application processor(s) (or processing circuitry) 1106 when executing software. The cellular baseband processor(s) (or processing circuitry) 1124/application processor(s) (or processing circuitry) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) (or processing circuitry) 1124 and/or the application processor(s) (or processing circuitry) 1106, and in another configuration, the apparatus 1104 may be the entire UE (e.g., see UE 350 of FIG. 3) and include the additional modules of the apparatus 1104.

As discussed supra, the component 198 may be configured to receive, from a network entity, a PDCCH transmission in a CORESET spanning multiple symbols, where the PDCCH transmission includes multiple DMRS having a DMRS pattern based on a duration of the CORESET, where the DMRS pattern is in at least one of a time domain or a frequency domain; and perform a channel estimation based on the DMRS. The component 198 may be further configured to perform any of the aspects described in connection with the flowcharts in FIG. 7 and FIG. 8, and/or performed by the UE 602 in FIG. 6. The component 198 may be within the cellular baseband processor(s) (or processing circuitry) 1124, the application processor(s) (or processing circuitry) 1106, or both the cellular baseband processor(s) (or processing circuitry) 1124 and the application processor(s) (or processing circuitry) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) (or processing circuitry) 1124 and/or the application processor(s) (or processing circuitry) 1106, includes means for receiving, from a network entity, a PDCCH transmission in a CORESET spanning multiple symbols, where the PDCCH transmission includes multiple DMRS having a DMRS pattern based on a duration of the CORESET, where the DMRS pattern is in at least one of a time domain or a frequency domain; and means for performing a channel estimation based on the DMRS. The apparatus 1104 may further include means for performing any of the aspects described in connection with the flowcharts in FIG. 7 and FIG. 8, and/or aspects performed by the UE 602 in FIG. 6. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

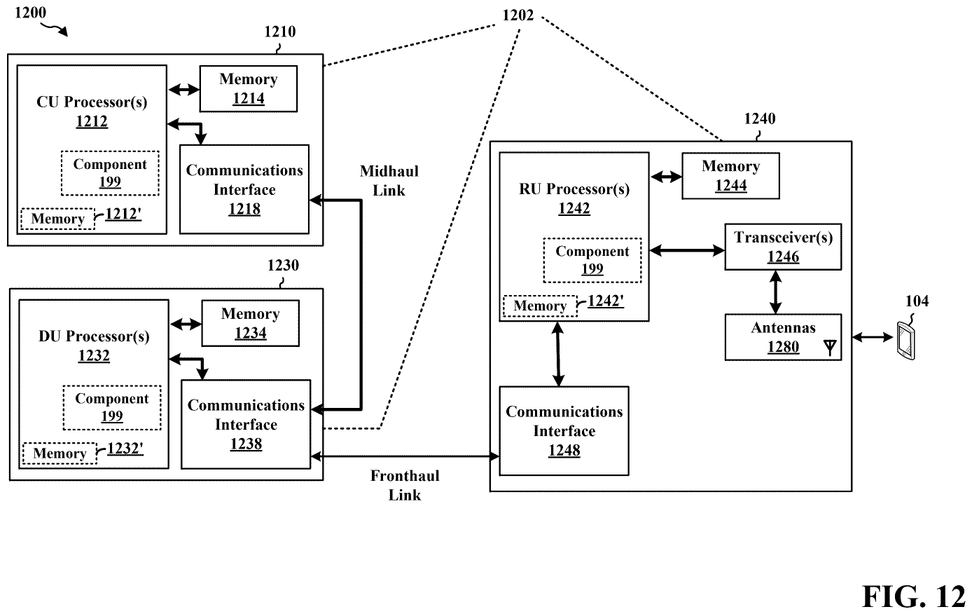

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor (or processing circuitry) 1212. The CU processor(s) (or processing circuitry) 1212 may include on-chip memory (or memory circuitry) 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor (or processing circuitry) 1232. The DU processor(s) (or processing circuitry) 1232 may include on-chip memory (or memory circuitry) 1232′. In some aspects, the DU 1230 may further include additional memory modules 1234 and a communications interface 1238. The DU 1230 communicates with the RU 1240 through a fronthaul link. The RU 1240 may include at least one RU processor (or processing circuitry) 1242. The RU processor(s) (or processing circuitry) 1242 may include on-chip memory (or memory circuitry) 1242′. In some aspects, the RU 1240 may further include additional memory modules 1244, one or more transceivers 1246, antennas 1280, and a communications interface 1248. The RU 1240 communicates with the UE 104. The on-chip memory (or memory circuitry) 1212′, 1232′, 1242′ and the additional memory modules 1214, 1234, 1244 may each be considered a computer-readable medium/memory (or memory circuitry). Each computer-readable medium/memory (or memory circuitry) may be non-transitory. Each of the processors (or processing circuitry) 1212, 1232, 1242 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to transmit, to a UE, a PDCCH transmission in a CORESET spanning multiple symbols, where the PDCCH transmission includes multiple DMRS having a DMRS pattern based on a duration of the CORESET, where the DMRS pattern is in at least one of a time domain or a frequency domain; and communicate with the UE based on the DMRS. The component 199 may be further configured to perform any of the aspects described in connection with the flowcharts in FIG. 9 and FIG. 10, and/or performed by the base station 604 in FIG. 6. The component 199 may be within one or more processors (or processing circuitry) of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 includes means for transmitting, to a UE, a PDCCH transmission in a CORESET spanning multiple symbols, where the PDCCH transmission includes multiple DMRS having a DMRS pattern based on a duration of the CORESET, where the DMRS pattern is in at least one of a time domain or a frequency domain; and means for communicating with the UE based on the DMRS. The network entity 1202 may further include means for performing any of the aspects described in connection with the flowcharts in FIG. 9 and FIG. 10, and/or aspects performed by the base station 604 in FIG. 6. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving, from a network entity, a PDCCH transmission in a CORESET spanning multiple symbols, where the PDCCH transmission includes multiple DMRS having a DMRS pattern based on a duration of the CORESET, where the DMRS pattern is in at least one of a time domain or a frequency domain; and performing a channel estimation based on the DMRS. By providing a cluster-based DMRS pattern for a long CORESET, where the DMRS is concentrated at the beginning and end of CORESET symbols, the methods reduce unnecessary repetition of DMRS across all CORESET symbols, thereby minimizing the overhead and improving the efficiency of resource allocations in wireless communication. Additionally, by varying the DMRS density across the DMRS clusters within the CORESET (e.g., the DMRS density of an earlier cluster is an integer multiple of that in a later cluster), the methods allow for possible early termination of PDCCH decoding if the DMRS is not detected, thereby reducing power consumption without degrading channel estimation performance.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method includes receiving, from a network entity, a physical downlink control channel (PDCCH) transmission in a control resource set (CORESET) spanning multiple symbols, wherein the PDCCH transmission includes multiple demodulation reference signals (DMRS) having a DMRS pattern based on a duration of the CORESET, wherein the DMRS pattern is in at least one of a time domain or a frequency domain; and performing a channel estimation based on the DMRS.

Aspect 2 is the method of aspect 1, wherein the multiple symbols include more than three symbols.

Aspect 3 is the method of any of aspects 1 to 2, wherein the DMRS pattern comprises multiple DMRS clusters in the time domain, and wherein at least two DMRS clusters of the multiple DMRS clusters are separated by one or more symbols that contain no DMRS transmissions.

Aspect 4 is the method of aspect 3, wherein the at least two DMRS clusters have a same DMRS density in the frequency domain.

Aspect 5 is the method of aspect 3, wherein the at least two DMRS clusters include an earlier DMRS cluster and a later DMRS cluster located after the earlier DMRS cluster, wherein the earlier DMRS cluster has a first DMRS density in the frequency domain, and the later DMRS cluster has a second DMRS density in the frequency domain, and wherein the first DMRS density is different from the second DMRS density and is an integer multiple of the second DMRS density.

Aspect 6 is the method of aspect 3, wherein the at least two DMRS clusters include a first DMRS cluster comprising at least one symbol at a beginning of the CORESET and a second DMRS cluster comprising at least one symbol at an end of the CORESET, and wherein the first DMRS cluster has a first DMRS density in the frequency domain across the at least one symbol in the first DMRS cluster, and the second DMRS cluster has a second DMRS density in the frequency domain across the at least one symbol in the second DMRS cluster.

Aspect 7 is the method of aspect 6, wherein the first DMRS density is equal to the second DMRS density.

Aspect 8 is the method of aspect 6, wherein the first DMRS density is different from the second DMRS density and is an integer multiple of the second DMRS density.

Aspect 9 is the method of aspect 3, where the method further includes receiving, via radio resource control (RRC) signaling, a CORESET configuration, wherein the CORESET configuration indicates the DMRS pattern.

Aspect 10 is the method of aspect 9, the CORESET configuration further comprises one or more of: a number of clusters in the multiple DMRS clusters, or a DMRS density for each DMRS cluster in the multiple DMRS clusters.

Aspect 11 is the method of any of aspects 1 to 3, wherein the DMRS pattern is associated with a CORESET index.

Aspect 12 is the method of aspect 11, where the method further includes determining, based on a predetermined mapping relationship between CORESET indices and DMRS patterns, the DMRS pattern.

Aspect 13 is an apparatus for wireless communication at a UE, comprising: a processing system that includes processor circuitry and memory circuitry that stores code and is coupled with the processor circuitry, the processing system configured to cause the UE to perform the method of one or more of aspects 1-12.

Aspect 14 is an apparatus for wireless communication at a UE, comprising: at least one memory; and at least one processor coupled to the at least one memory and, where the at least one processor is configured to perform the method of any of aspects 1-12.

Aspect 15 is the apparatus for wireless communication at a UE, comprising means for performing each step in the method of any of aspects 1-12.

Aspect 16 is an apparatus of any of aspects 13-15, further comprising a transceiver configured to receive or to transmit in association with the method of any of aspects 1-12.

Aspect 17 is a computer-readable medium (e.g., a non-transitory computer-readable medium) storing computer executable code at a UE, the code when executed by at least one processor causes the at least one processor to perform the method of any of aspects 1-12.

Aspect 18 is a method of wireless communication at a network entity. The method includes transmitting, to a user equipment (UE), a physical downlink control channel (PDCCH) transmission in a control resource set (CORESET) spanning multiple symbols, wherein the PDCCH transmission includes multiple demodulation reference signals (DMRS) having a DMRS pattern based on a duration of the CORESET, wherein the DMRS pattern is in at least one of a time domain or a frequency domain; and communicating with the UE based on the DMRS.

Aspect 19 is the method of aspect 18, wherein the multiple symbols include more than three symbols.

Aspect 20 is the method of any of aspects 18 to 19, wherein the DMRS pattern comprises multiple DMRS clusters in the time domain, wherein at least two DMRS clusters of the multiple DMRS clusters are separated by one or more symbols that contain no DMRS transmissions.

Aspect 21 is the method of aspect 20, wherein the at least two DMRS clusters have a same DMRS density in the frequency domain.

Aspect 22 is the method of aspect 20, wherein the at least two DMRS clusters include an earlier DMRS cluster and a later DMRS cluster located after the earlier DMRS cluster, wherein the earlier DMRS cluster has a first DMRS density in the frequency domain, and the later DMRS cluster has a second DMRS density in the frequency domain, and wherein the first DMRS density is different from the second DMRS density and is an integer multiple of the second DMRS density.

Aspect 23 is the method of aspect 20, wherein the at least two DMRS clusters includes a first DMRS cluster comprising at least one symbol at a beginning of the CORESET and a second DMRS cluster comprising at least one symbol at an end of the CORESET, and wherein the first DMRS cluster has a first DMRS density in the frequency domain across the at least one symbol in the first DMRS cluster, and the second DMRS cluster has a second DMRS density in the frequency domain across the at least one symbol in the second DMRS cluster.

Aspect 24 is the method of aspect 23, wherein the first DMRS density is equal to the second DMRS density.

Aspect 25 is the method of aspect 23, wherein the first DMRS density is different from the second DMRS density and is an integer multiple of the second DMRS density.

Aspect 26 is the method of any of aspects 20 to 25, where the method further includes transmitting, via radio resource control (RRC) signaling, a CORESET configuration, wherein the CORESET configuration indicates the DMRS pattern.

Aspect 27 is the method of aspect 26, wherein the CORESET configuration further comprises one or more of: a number of clusters in the multiple DMRS clusters, or a DMRS density for each DMRS cluster in the multiple DMRS clusters.

Aspect 28 is the method of aspect 20, wherein the DMRS pattern is associated with a CORESET index.

Aspect 29 is the method of aspect 28, wherein the DMRS pattern is based on a predetermined mapping relationship between CORESET indices and DMRS patterns.

Aspect 30 is an apparatus for wireless communication at a network entity, comprising: a processing system that includes processor circuitry and memory circuitry that stores code and is coupled with the processor circuitry, the processing system configured to cause the network entity to perform the method of one or more of aspects 18-29.

Aspect 31 is an apparatus for wireless communication at a network entity, comprising: at least one memory; and at least one processor coupled to the at least one memory and, where the at least one processor is configured to perform the method of any of aspects 18-29.

Aspect 32 is the apparatus for wireless communication at a network entity, comprising means for performing each step in the method of any of aspects 18-29.

Aspect 33 is an apparatus of any of aspects 30-32, further comprising a transceiver configured to receive or to transmit in association with the method of any of aspects 18-29.

Aspect 34 is a computer-readable medium (e.g., a non-transitory computer-readable medium) storing computer executable code at a network entity, the code when executed by at least one processor causes the at least one processor to perform the method of any of aspects 18-29.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
receive, from a network entity, a physical downlink control channel (PDCCH) transmission in a control resource set (CORESET) spanning multiple symbols, wherein the PDCCH transmission includes multiple demodulation reference signals (DMRS) having a DMRS pattern based on a duration of the CORESET, wherein the DMRS pattern is in at least one of a time domain or a frequency domain; and
perform a channel estimation based on the DMRS.

2. The apparatus of claim 1, further comprising a transceiver coupled to the at least one processor, wherein to receive the PDCCH transmission, the at least one processor is configured to receive the PDCCH transmission via the transceiver, and wherein the multiple symbols include more than three symbols.

3. The apparatus of claim 1, wherein the DMRS pattern comprises multiple DMRS clusters in the time domain, and wherein at least two DMRS clusters of the multiple DMRS clusters are separated by one or more symbols that contain no DMRS transmissions.

4. The apparatus of claim 3, wherein the at least two DMRS clusters have a same DMRS density in the frequency domain.

5. The apparatus of claim 3, wherein the at least two DMRS clusters include an earlier DMRS cluster and a later DMRS cluster located after the earlier DMRS cluster, wherein the earlier DMRS cluster has a first DMRS density in the frequency domain, and the later DMRS cluster has a second DMRS density in the frequency domain, and wherein the first DMRS density is different from the second DMRS density and is an integer multiple of the second DMRS density.

6. The apparatus of claim 3, wherein the at least two DMRS clusters include a first DMRS cluster comprising at least one symbol at a beginning of the CORESET and a second DMRS cluster comprising at least one symbol at an end of the CORESET, and wherein the first DMRS cluster has a first DMRS density in the frequency domain across the at least one symbol in the first DMRS cluster, and the second DMRS cluster has a second DMRS density in the frequency domain across the at least one symbol in the second DMRS cluster.

7. The apparatus of claim 6, wherein the first DMRS density is equal to the second DMRS density.

8. The apparatus of claim 6, wherein the first DMRS density is different from the second DMRS density and is an integer multiple of the second DMRS density.

9. The apparatus of claim 3, wherein the at least one processor is further configured to:
receive, via radio resource control (RRC) signaling, a CORESET configuration, wherein the CORESET configuration indicates the DMRS pattern.

10. The apparatus of claim 9, wherein the CORESET configuration further comprises one or more of:
a number of clusters in the multiple DMRS clusters, or
a DMRS density for each DMRS cluster in the multiple DMRS clusters.

11. The apparatus of claim 3, wherein the DMRS pattern is associated with a CORESET index.

12. The apparatus of claim 11, wherein the at least one processor is further configured to:
determine, based on a predetermined mapping relationship between CORESET indices and DMRS patterns, the DMRS pattern.

13. An apparatus for wireless communication at a network entity, comprising:
at least one memory; and
at least one processor coupled to the at least one memory and, based at least in part on information stored in the at least one memory, the at least one processor is configured to:
transmit, to a user equipment (UE), a physical downlink control channel (PDCCH) transmission in a control resource set (CORESET) spanning multiple symbols, wherein the PDCCH transmission includes multiple demodulation reference signals (DMRS) having a DMRS pattern based on a duration of the CORESET, wherein the DMRS pattern is in at least one of a time domain or a frequency domain; and
communicate with the UE based on the DMRS.

14. The apparatus of claim 13, further comprising a transceiver coupled to the at least one processor, wherein to transmit the PDCCH transmission, the at least one processor is configured to transmit the PDCCH transmission via the transceiver, wherein the multiple symbols include more than three symbols.

15. The apparatus of claim 13, wherein the DMRS pattern comprises multiple DMRS clusters in the time domain, wherein at least two DMRS clusters of the multiple DMRS clusters are separated by one or more symbols that contain no DMRS transmissions.

16. The apparatus of claim 15, wherein the at least two DMRS clusters have a same DMRS density in the frequency domain.

17. The apparatus of claim 15, wherein the at least two DMRS clusters include an earlier DMRS cluster and a later DMRS cluster located after the earlier DMRS cluster, wherein the earlier DMRS cluster has a first DMRS density in the frequency domain, and the later DMRS cluster has a second DMRS density in the frequency domain, and wherein the first DMRS density is different from the second DMRS density and is an integer multiple of the second DMRS density.

18. The apparatus of claim 15, wherein the at least two DMRS clusters includes a first DMRS cluster comprising at least one symbol at a beginning of the CORESET and a second DMRS cluster comprising at least one symbol at an end of the CORESET, and wherein the first DMRS cluster has a first DMRS density in the frequency domain across the at least one symbol in the first DMRS cluster, and the second DMRS cluster has a second DMRS density in the frequency domain across the at least one symbol in the second DMRS cluster.

19. The apparatus of claim 18, wherein the first DMRS density is equal to the second DMRS density.

20. The apparatus of claim 18, wherein the first DMRS density is different from the second DMRS density and is an integer multiple of the second DMRS density.

21. The apparatus of claim 15, wherein the at least one processor is further configured to:
transmit, via radio resource control (RRC) signaling, a CORESET configuration, wherein the CORESET configuration indicates the DMRS pattern.

22. The apparatus of claim 21, wherein the CORESET configuration further comprises one or more of:
a number of clusters in the multiple DMRS clusters, or
a DMRS density for each DMRS cluster in the multiple DMRS clusters.

23. The apparatus of claim 15, wherein the DMRS pattern is associated with a CORESET index.

24. The apparatus of claim 23, wherein the DMRS pattern is based on a predetermined mapping relationship between CORESET indices and DMRS patterns.

25. A method of wireless communication at a user equipment (UE), comprising:
receiving, from a network entity, a physical downlink control channel (PDCCH) transmission in a control resource set (CORESET) spanning multiple symbols, wherein the PDCCH transmission includes multiple demodulation reference signals (DMRS) having a DMRS pattern based on a duration of the CORESET, wherein the DMRS pattern is in at least one of a time domain or a frequency domain; and
performing a channel estimation based on the DMRS.

26. The method of claim 25, wherein the multiple symbols include more than three symbols.

27. The method of claim 25, wherein the DMRS pattern comprises multiple DMRS clusters in the time domain, wherein at least two DMRS clusters of the multiple DMRS clusters are separated by one or more symbols that contain no DMRS transmissions.

28. The method of claim 27, wherein the at least two DMRS clusters have a same DMRS density in the frequency domain.

29. The method of claim 27, wherein the at least two DMRS clusters include an earlier DMRS cluster and a later DMRS cluster located after the earlier DMRS cluster, wherein the earlier DMRS cluster has a first DMRS density in the frequency domain, and the later DMRS cluster has a second DMRS density in the frequency domain, and wherein the first DMRS density is different from the second DMRS density and is an integer multiple of the second DMRS density.

30. A method of wireless communication at a network entity, comprising:
transmitting, to a user equipment (UE), a physical downlink control channel (PDCCH) transmission in a control resource set (CORESET) spanning multiple symbols, wherein the PDCCH transmission includes multiple demodulation reference signals (DMRS) having a DMRS pattern based on a duration of the CORESET, wherein the DMRS pattern is in at least one of a time domain or a frequency domain; and
communicating with the UE based on the DMRS.
